(19) United States
(12) Patent Application Publication
(10) Pub. No.: US 2013/0344799 A1
(43) Pub. Date: Dec. 26, 2013

(54) SYSTEM FOR DELIVERY OF RADIO CONTENT AND METHOD OF DELIVERING RADIO CONTENT

(71) Applicants: Stephen M. Cichy, Lapeer, MI (US); Erik C. Nordstrom, Troy, MI (US); Charles J. Swan, Farmington Hills, MI (US); Ryan A. Church, Oxford, MI (US)

(72) Inventors: Stephen M. Cichy, Lapeer, MI (US); Erik C. Nordstrom, Troy, MI (US); Charles J. Swan, Farmington Hills, MI (US); Ryan A. Church, Oxford, MI (US)

(73) Assignee: GM GLOBAL TECHNOLOGY OPERATIONS LLC, Detroit, MI (US)

(21) Appl. No.: 13/530,873

(22) Filed: Jun. 22, 2012

(51) Int. Cl. H04H 20/00; H04W 4/04

(52) U.S. Cl. 455/3.06; 455/3.01

(57) ABSTRACT

A system for delivery of radio content includes a database configured to receive a radio content data comprising a radio content, a broadcast time for the radio content and a broadcast channel of the radio content. Also included is a signal for communicating the radio content from the database to a remote radio unit, wherein the remote radio unit communicates the radio content data to a user for providing advance notice to the user of future radio content.

### FIELD OF THE INVENTION

The subject invention relates to radio content, and more particularly to a system and a method of delivering such radio content.

### BACKGROUND

Many vehicles have or are modified to include user interface devices that provide various services to a user. Such services include, but are not limited to, directions and other navigation-related services, airbag deployment notification and other emergency or roadside assistance-related services provided in connection with various crash and/or collision sensor interface modules and sensors located throughout the vehicle. Additionally, services include “infotainment-related” services where music radio content, Web pages, movies, television programs, videogames and/or other content is downloaded to the user interface devices.

Current user interface devices, with respect to radio content, provide various data to a user relating to current radio content, but fail to provide meaningful advance notice to the user of future radio content on a plurality of broadcast channels available to the user.

### SUMMARY OF THE INVENTION

In one exemplary embodiment of the invention, a system for delivery of radio content includes a database configured to receive a radio content data comprising a radio content, a broadcast time for the radio content and a broadcast channel of the radio content. Also included is a signal for communicating the radio content from the database to a remote radio unit, wherein the remote radio unit communicates the radio content data to a user for providing advance notice to the user of future radio content.

In another exemplary embodiment of the invention, a system for delivery of radio content includes a database configured to receive a radio content data comprising a radio content, a broadcast time for the radio content and a broadcast channel of the radio content. Also included is a signal for communicating the radio content data from the database to a user for providing advance notice to the user of future radio content, wherein the user selectively determines a listening schedule. Further included is a radio unit controller for switching between a plurality of broadcast channels in response to input from the listening schedule.

In yet another exemplary embodiment of the invention, a method of delivering radio content is provided. The method includes providing a radio content data to a database for storing and processing the radio content, wherein the radio content data comprises a radio content, a broadcast time for the radio content and a broadcast channel of the radio content. Also included is transmitting the radio content data to a remote radio unit for processing therein. Further included is communicating current radio content data and future radio content data to a user.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic illustration of a system for delivery of radio content to a remote radio unit;

FIG. 2 is a schematic illustration of an exemplary embodiment of the system for delivery of radio content;

FIG. 3 is a schematic illustration of a vehicle integrated with the system for delivery of radio content;

FIG. 4 is a schematic illustration of a graphical user interface of the system for delivery of radio content, the graphical user interface displaying radio content data;

FIG. 5 is a schematic illustration of a programmable radio system used in conjunction with the system for delivery of radio content; and

FIG. 6 is a flow diagram illustrating a method of delivering radio content.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

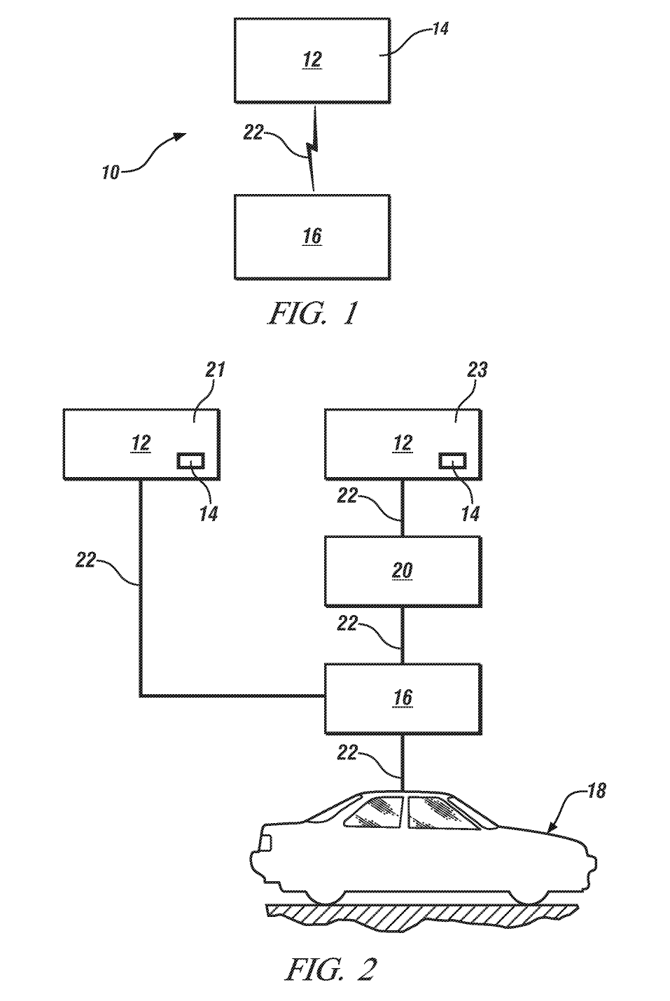

Referring to FIG. 1, in accordance with an exemplary embodiment of the invention, a simplified schematic representation of a system for delivery of radio content is generally referred to with numeral 10. The system for delivery of radio content 10 comprises a communication and control system that generally includes a database 12 that stores radio content data 14 in the form of radio broadcast files. The radio content data 14, and more specifically the radio broadcast files, contain a variety of information relating to radio broadcasting. It is to be appreciated that reference to the term radio is to be interpreted broadly, such that all broadcast radio content is to be defined by the term. Examples of such broadcast radio content includes transmittal by AM, FM and satellite systems or any other wireless or wired connection to the radio.

The broadcast radio content comprises various transmitted programs, including music, news, sports and talk radio, for example, however, it is to be understood that the preceding list of examples are merely illustrative and numerous other categories of broadcast radio content are contemplated. The radio content data 14 further includes information relating to the broadcast radio content, irrespective of the category of broadcast radio content. Such information may include, but is not limited to, identification of the broadcast radio content, a broadcast time for the broadcast radio content, transmitted programs, songs, genre, as well as a broadcast channel. One aspect or all of the aforementioned information may be included.

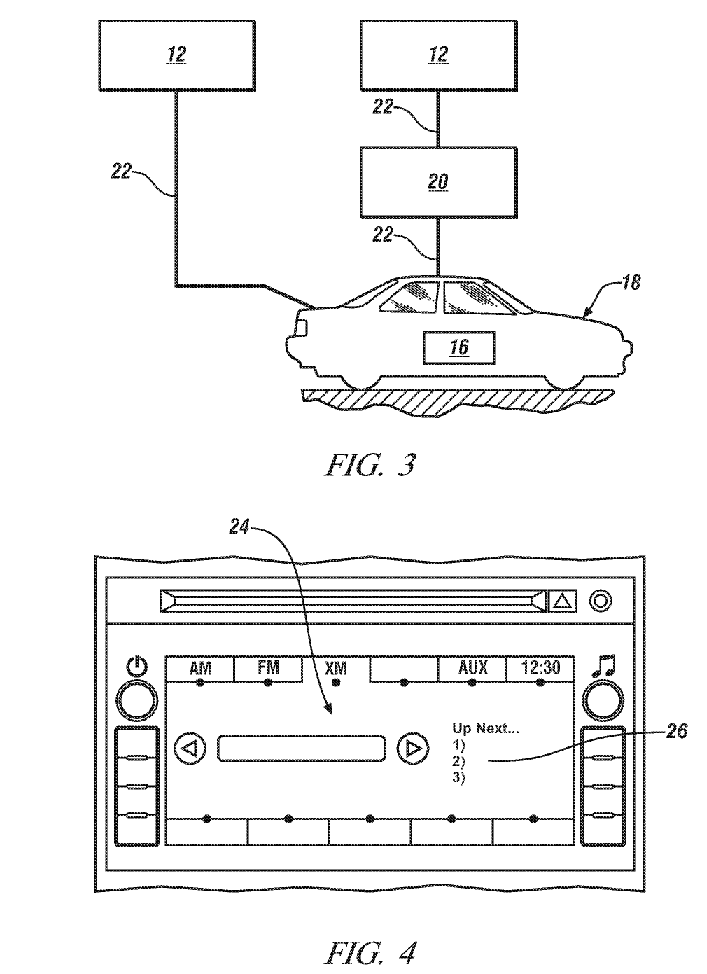

A remote radio unit 16 is configured to receive the radio content data 14 via a signal 22 from the database 12. The remote radio unit 16 may be in the form of a variety of embodiments having a radio integrated therein for entertainment of a user. Merely illustrative examples include various personal electronic devices, including a cellular phone, a personal computer, a portable music device and a MP3 player. Additionally, as will be described below with reference to FIGS. 2 and 3, the remote radio unit 16 may be disposed within a vehicle.

Referring now to FIGS. 2 and 3, as noted above, the remote radio unit 16 may be disposed within a vehicle 18, or used in conjunction with the vehicle 18. The vehicle 18 may be a motorcycle, car, truck, recreational vehicle (RV), boat, plane, etc., and is equipped with suitable hardware and software that enables it to communicate with the system for delivery of radio content 10. Communication with the system for delivery of radio content 10 includes sending and/or receiving of a variety of data, including the radio content data 14 described above. The database 12 may refer to a radio tower 21 that communicates signals at various frequencies, in addition to the previously described radio content data 14 to the remote radio unit 16. Alternatively, or in combination with the radio tower, the database 12 may comprise a satellite radio broadcast operations center 23 that transmits the radio content data 14 to the remote radio unit 16. In the case of a satellite radio broadcast operations center 23, the signal 22 is transmitted as a file data stream from a central facility to the satellite radio broadcast operations center 23. From the broadcast operations center 23, the signal 22 containing the radio content data 14 is communicated to a satellite 20 which then directs the signal 22 to the remote radio unit 16.

The remote radio unit 16 is thereby configured to receive the radio content data 14, whether installed directly within the vehicle 18 or disposed at a remote location, such as a personal electronic device, for example, that then communicates the radio content data 14 to the vehicle 18. Upon receipt of the radio content data 14, the remote radio unit 16, whether a personal electronic device or a radio unit integrated within the vehicle 18, extraction of appropriate files from the signal 22 is performed and converted to an understandable communication to the user. Such a communication may be in the form of audio prompts or visual display on a graphical user interface (GUI) 24 (FIG. 4). The GUI 24 may comprise a liquid crystal display (“LCD”) screen and is used to display graphics and/or text. In one embodiment, the GUI 24 may have color display capability. In the case of the GUI 24, current and future radio content is graphically illustrated to the user in the form of a list 26, for example. The list 26 may include a predetermined number of songs, topics or sporting events that will be available on the current and/or other broadcast channels. Alternatively, the list 26 may include radio content data 14 available for a predetermined future radio content time period comprising future time periods. The list 26 provides the user the ability to preferentially determine the listened to future radio content. For example, rather than “looking” for desirable radio content by switching between a plurality of broadcast channels, the user may simply refer to the list 26 provided to determine what broadcast channel to switch to.

In contemplated embodiments that only provide the user with future radio content information relating to a current broadcast channel, the user is assisted by the provision of future radio content. Based on the upcoming radio content, the user or any intelligent device may make a decision to continue listening to the current broadcast channel or seek alternative radio content on other available broadcast channels. As the user switches to various alternative broadcast channels, the list 26 provides the user with information relating to the upcoming radio content for that particular broadcast channel, thereby allowing the user to quickly determine whether to seek other radio content on other broadcast channels.

The aforementioned embodiments enable the user to make more informed choices regarding what broadcast channel to listen to. Whether the future radio content is provided visually or in the form of an audio prompt, the user avoids excessively listening to radio content that is less desirable than radio content available on other broadcast channels. Additionally, by providing the user with future broadcast data, informal short-term queues are effectively compiled by the user while listening to the radio content.

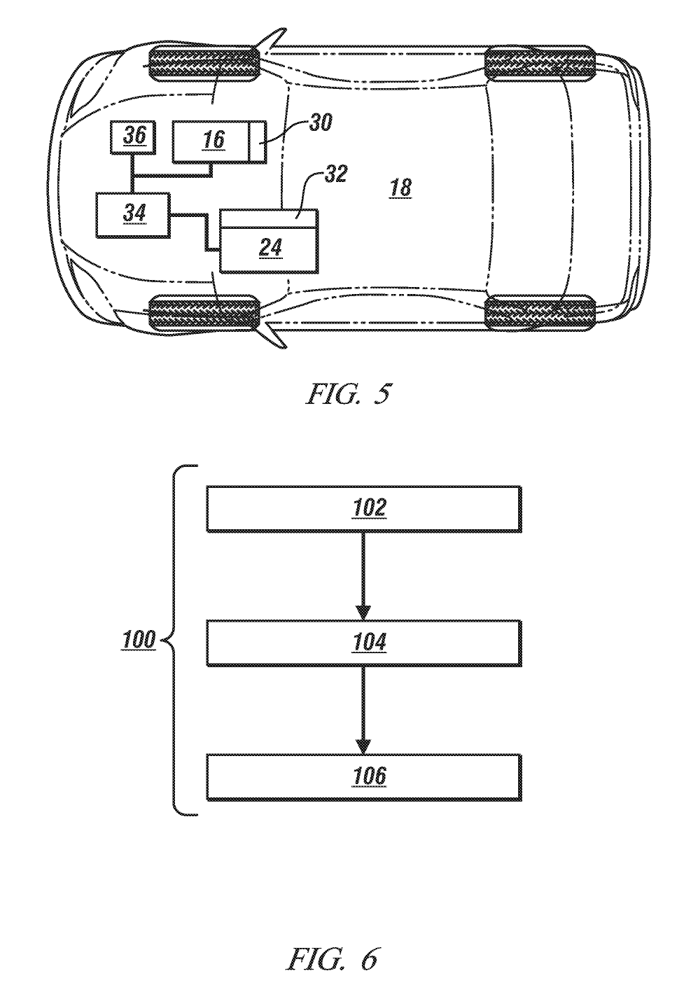

Referring now to FIG. 5, in an alternative embodiment, the user may compile relatively long-term programmed queues by interacting with a user interface 30 in communication with the remote radio unit 16 that is configured to receive the radio content data 14. As previously noted, the remote radio unit 16 may be a personal electronic device or a radio unit integrated with the vehicle 18. Irrespective of the embodiment of the remote radio unit 16, the user may review future broadcast data and selectively determine a program listening schedule 32 comprising scheduled radio content that the user desires to listen to. The program listening schedule 32 may be compiled remotely on a personal electronic device, such as a computer or cellular phone, for example. In such a case, the personal electronic device communicates the program listening schedule 32 to a module 34 disposed within the vehicle 18 for storage therein. Alternatively, in an embodiment where the remote radio unit 16 is directly integrated within the vehicle 18, the user may simply compile the program listening schedule 32 by interacting with an interface within the vehicle 18, such as the GUI 24, for example. In either embodiment, the module 34 communicates the program listening schedule 32 to a controller 36 that is configured to automatically switch between broadcast channels in response to the program listening schedule 32 commands. Therefore, at specified times within the program listening schedule 32, the controller 36 will switch to the programmed broadcast channel to provide the user with the desired and programmed radio content.

A method of delivering radio content 100 is also provided as illustrated in FIG. 6 and with reference to FIGS. 1-5. The system for delivery of radio content 10 has been previously described and specific structural components need not be described in further detail. The method of delivering radio content 100 includes providing a radio content data to a database for storing and processing the radio content data 102. As discussed above, the radio content data comprises music, news, sports, and talk radio, among other contemplated types or radio content. The radio content data is transmitted 104 over a wireless network, via a USB port from the user's personal device, or by any other wired connection to a remote radio unit for processing therein. Current and future radio content is communicated to a user 106. The method 100 thereby allows the user to make informed broadcast channel selections based on knowledge of future radio content available on a currently listened to broadcast channel, as well as other available broadcast channels.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A system for delivery of radio content comprising:
a database configured to receive a radio content data comprising a radio content, a broadcast time for the radio content and a broadcast channel of the radio content; and
a signal for communicating the radio content data from the database to a remote radio unit, wherein the remote radio unit communicates the radio content data to a user for providing advance notice to the user of future radio content.

2. The system for delivery of radio content of claim 1, wherein the radio content comprises at least one of music, news, sports and talk.

3. The system for delivery of radio content of claim 1, wherein the remote radio unit is integrated within a vehicle.

4. The system for delivery of radio content of claim 1, further comprising a graphical user interface configured to display the radio content to the user.

5. The system for delivery of radio content of claim 4, wherein the graphical user interface displays current and future radio content to the user.

6. The system for delivery of radio content of claim 1, wherein the future radio content provided to the user comprises a predetermined future radio content time period.

7. The system for delivery of radio content of claim 1, wherein the radio content data is provided to a personal electronic device.

8. The system for delivery of radio content of claim 1, further comprising a module configured to receive a program listening schedule from the user, wherein the program listening schedule comprises a pre-selected lineup of radio content.

9. The system for delivery of radio content of claim 8, further comprising a radio unit controller configured to automatically switch between a plurality of broadcast channels based on the program listening schedule.

10. A system for delivery of radio content comprising:
a database configured to receive a radio content data comprising a radio content, a broadcast time for the radio content and a broadcast channel of the radio content;
a signal for communicating the radio content data from the database to a user for providing advance notice to the user of future radio content, wherein the user selectively determines a listening schedule; and
a radio unit controller for switching between a plurality of broadcast channels in response to input from the listening schedule.

11. The system for delivery of radio content of claim 10, wherein the radio content comprises at least one of music, news, sports and talk.

12. The system for delivery of radio content of claim 10, wherein the remote radio unit is integrated within a vehicle.

13. The system for delivery of radio content of claim 10, further comprising a graphical user interface configured to display current and future radio content to the user.

14. The system for delivery of radio content of claim 13, wherein the future radio content provided to the user comprises a predetermined future radio content time period.

15. The system for delivery of radio content of claim 10, wherein the radio content data is provided to a personal electronic device.

16. A method of delivering radio content comprising:
providing a radio content data to a database for storing and processing the radio content data, wherein the radio content data comprises a radio content, a broadcast time for the radio content and a broadcast channel of the radio content;
transmitting the radio content data over a wireless network to a remote radio unit for processing therein; and
communicating current radio content data and future radio content data to a user.

17. The method of claim 16, further comprising selectively programming a listening schedule by the user.

18. The method of claim 17, further comprising switching between a plurality of broadcast channels in response to input from the listening schedule.

19. The method of claim 16, further comprising displaying the future radio content data on a graphical user interface for the user to selectively choose between upcoming ratio content on a plurality of broadcast channels.

20. The method of claim 16, further comprising transmitting the radio content data to a personal electronic device, wherein the user selectively programs a listening schedule on the personal electronic device, and further comprising transmitting the listening schedule from the personal electronic device to the remote radio unit.
